(19) United States
(12) Patent Application Publication
(10) Pub. No.: US 2006/0238508 A1
(43) Pub. Date: Oct. 26, 2006

(54) Optical location measuring system

(76) Inventors: Tong Xie, San Jose, CA (US); Michael John Brosnan, Fremont, CA (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/112,024

(22) Filed: Apr. 22, 2005

(51) Int. Cl. G09G 5/08

(52) U.S. Cl. 345/166

(57) ABSTRACT

An optical location measuring system is provided including taking a reference image, taking a later image, comparing the reference image and the later image to determine a number of integer and non-integer pixels of movement, and taking a new reference image when the number of pixels of movement is substantially an integer number of pixels.

### BACKGROUND ART

The present invention relates generally to optical sensors, and more particularly to optical mouse sensors.

Over the years, different functional control devices for use with computer display systems have been developed. These devices have taken several forms, such as joysticks, light pens, touch panels, and handheld cursor control devices.

One of the most prevalent of these devices is the computer “mouse”. The mouse is moved across a surface such as a “mouse pad” to selectively move a cursor across a display screen. The mouse tracks the movement of the user's hand as the user moves the mouse about the mouse pad, usually next to the user's keyboard input to the computer system.

The mouse is subject to wear and tear on its mechanical rollers and sensors, so development of the mouse along one line has been to eliminate moving parts by using optics and optical detection of mouse tracking functions. This development has resulted in the optical mouse that detects motion relative to the mouse body independent of mouse rotation and independent of any inherent coordinate system employed with the mouse for tracking.

The current accuracy of the optical mouse is sufficient for moving a cursor around a display screen when the user is looking at the cursor. High accuracy is not required because the user's brain will correct for errors in the cursor location by causing the user's hand to unconsciously correct for any mistaken motions of the hand or mistaken motions reported by the mouse.

Other mistaken motions by the mouse are due to noise and error in the optical mouse itself. Especially since the optical mouse is being made for the low-cost, high-volume consumer product market, the precision of the system is sacrificed to reduce the complexity of the system until the errors are appropriate for the market. For example, for the typical optical mouse moving across a piece of paper for a movement of about ten inches, the error will be about one percent.

For a long time, those skilled in the art have been trying to develop a more accurate optical mouse sensor that could be used in measurement applications; e.g., to measure movements. However, it has not been possible to use an optical mouse in measurement applications because of the difficulty of achieving significant accuracy with existing optical sensors.

There have been difficulties first in obtaining the accuracy, and second in having a device that is low cost.

Solutions to these problems have been long sought but prior developments have not taught or suggested any solutions and, thus, solutions to these problems have long eluded those skilled in the art.

### DISCLOSURE OF THE INVENTION

The present invention provides an optical location measuring system including taking a reference image, taking a later image, comparing the reference image and the later image to determine a number of integer and non-integer pixels of movement, and taking a new reference image when the number of pixels of movement is substantially an integer number of pixels. This invention provides a low-cost, accurate optical sensor system for measurement applications.

Certain embodiments of the invention have various advantages in addition to or in place of those mentioned above or obvious from the above. These advantages will become apparent to those skilled in the art from a reading of the following detailed description when taken with reference to the accompanying drawings.

### BRIEF DESCRIPTION OF THE DRAWINGS

FIG. 1 a view of an optical location measuring system in accordance with an embodiment of the present invention;

FIG. 2 is an exemplary view of a reference image taken by an optical mouse sensor shown in FIG. 1 in accordance with an embodiment of the present invention;

FIG. 3 is an exemplary view of a later image taken by an optical mouse sensor shown in FIG. 1 in accordance with an embodiment of the present invention;

FIG. 4 is an exemplary view of a new reference image taken by an optical mouse sensor shown in FIG. 1 in accordance with an embodiment of the present invention;

FIG. 5 is a close-up example of a surface characteristic in an image;

FIG. 6 is a close-up example of the surface characteristic of FIG. 6 after approximately a half-pixel movement;

FIG. 7 is a graph of probable error versus pixel movement of an image;

FIG. 8 is a flow chart of an optical location measuring system in accordance with an embodiment of the present invention; and

FIG. 9 is a flow chart of an optical location measuring system in accordance with another embodiment of the present invention.

### BEST MODE FOR CARRYING OUT THE INVENTION

The following embodiments are described in sufficient detail to enable those skilled in the art to make and use the invention, and it is to be understood that other embodiments would be evident based on the present disclosure and that process or mechanical changes may be made without departing from the scope of the present invention.

In the following description, numerous specific details are given to provide a thorough understanding of the invention. However, it will apparent that the invention may be practiced without these specific details. In order to avoid obscuring the present invention, some well-known system configurations and process steps are not disclosed in detail.

Likewise, the drawings showing embodiments of the invention are semi-diagrammatic and not to scale and, particularly, some of the dimensions are for the clarity of presentation and are shown greatly exaggerated in the FIGs.

In addition, where multiple embodiments are disclosed and described having some features in common, for clarity and ease of illustration and description thereof like features one to another will ordinarily be described with like reference numerals.

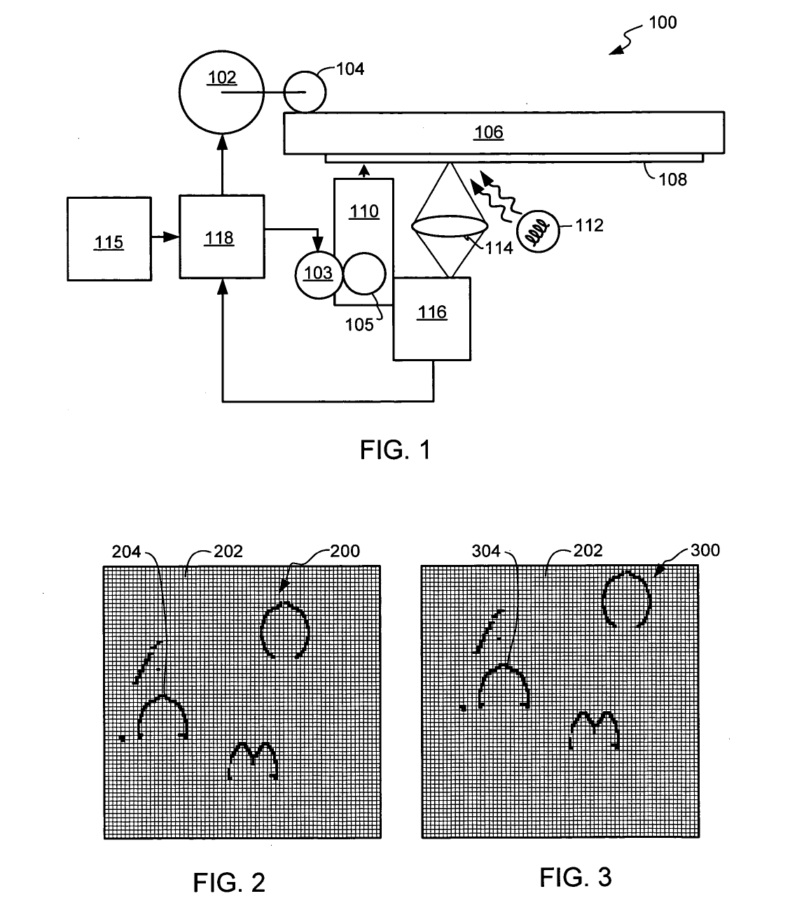

Referring now to FIG. 1, therein is shown an optical location measuring system 100. The system 100 is partially represented by a motor 102 driving a gear and mechanical system 104 to move a chassis 106 in an X-direction. The chassis 106 carries an object 108, such as a sheet of paper. The system 100 is also partially represented by a motor 103 driving a gear and mechanical system 105 to move a device 110 in a Y-direction. The device 110 performs an operation on the object 108. For example, the device 110 can be a device such as an inkjet printer for placing ink spots in extremely precise locations on a sheet of paper. The X-position of the paper and the Y-position of the inkjet printer would be set and measured by a computer 115, such as a personal computer.

A light source 112 lights the object 108. The light from the light source 112 passes through a lens 114 to form an image of the surface of the object 108 on to a light detector or optical sensor, such as an optical mouse sensor 116. The optical mouse sensor 116 provides signals of the image to a control processor 118, which controls the motor 102.

In one embodiment of the present invention, when the computer 115 has the control processor 118 drive the motors 102 and 103 move the object 108, the optical mouse sensor 116 provides image data to the control processor 118. This permits extremely precise control over printing.

However, there are errors inherent in the measurements, which accumulate with increasing movement. These errors are due to the nature of the algorithm that is used by the optical mouse sensor 116. Fundamentally, the errors accumulate because the optical mouse sensor 116 can only image very small areas of the surface of the object 108 and make measurements by making many small measurements, which each have very small random errors.

The optical mouse sensor 116 takes images in microscopic detail of the object 108. Images of fibers, imperfections, and other microscopic details are imaged. As long as the images overlap, the number of pixels movement between a reference image and a later image can be counted by determining how many pixels back the later image must be moved to be the same as the reference image.

When the object 108 moves past the point at which the reference image and the later image no longer overlap, the reference image cannot be compared to the later image to measure the amount of movement. Therefore, before the images no longer overlap, a new reference image must be selected. The selection of the new reference image is called a re-referencing operation.

Each time the optical mouse sensor 116 performs a new re-referencing operation, a certain amount of error is introduced in the measured movement between the reference image and the new image. This is because there are only a certain number of pixels in the image and, when the later image moves more or less than an integer or whole number of pixels, the actual value of the uneven pixel movement has a certain degree of uncertainty or random error. It is possible to determine half-pixels, quarter-pixels, or even smaller sub-pixels; although it is difficult to determine one-tenth pixels.

Further, when keeping the same reference image and making an estimate of movement on a series of images, each one of those images has some random error due to the inability to measure down to the millionth of a pixel level. Typically, errors on the order of a tenth of a pixel occur whenever a measurement is made.

Even further, the error has a random component with regard to direction, so when the surface of the object 108 lies in an X-Y plane, the errors will be independent and random in the X and Y directions.

By way of example, if ten measurements are made using the same reference image, each measurement has a random error, such as a tenth-pixel in the X and Y direction, which is independent and not cumulative. When the tenth image is reached which still uses the reference image, the tenth image still has a tenth-pixel random error in an unknown direction. The re-referencing operation performed using the tenth image as the new reference image for future measurements causes the new reference image to include the tenth-pixel error.

After ten re-referencing operations, it is possible in the worst case to have the measurement off by more than one pixel, which is unacceptable even for a mouse moving a cursor around a display screen. One-tenth pixel errors on every re-reference may be borderline for cursor control, but not for printer control.

It has been found that, when more than one-third of the reference image is missing from a later image, a re-referencing operation should be performed. However, it may be performed both more and less infrequently depending on the system. But in any event, there may be many more re-referencing operations than ten during a movement across the object 108.

Referring now to FIG. 2, therein is shown an exemplary view of a reference image 200 taken by the optical mouse sensor 116 shown in FIG. 1 in accordance with an embodiment of the present invention. For example, the reference image 200 is made up of a large number of pixels 202. A surface characteristic, such as a curved paper fiber 204, would be comprised of a group of pixels of roughly 12×12 pixels.

Referring now to FIG. 3, therein is shown an exemplary view of a later image 300 taken by the optical mouse sensor 116 shown in FIG. 1 in accordance with an embodiment of the present invention. For example, the later image 300 has moved roughly twelve pixels to the right in an X direction and twelve pixels up in a Y direction. The curved paper fiber 204 of FIG. 2 is now comprised of different pixels that form a curved paper fiber 304.

Closer examination is required to determine if the curved paper fiber 304 has moved more than twelve pixels but less than thirteen pixels. However, it is possible to determine approximately how far the image has moved by carefully comparing all the edges of all the letters and interpolating in between the two integer values how much movement has occurred.

Since it would not be possible to determine precisely by interpolation, there will be random error each time a measurement is performed.

It is possible to continue to use the reference image 200 of FIG. 2 as new images, such as a later image 300 are created and the curved paper fiber continues to move even further to the right. As would be evident, the random errors would continue, but they would all be relative to the reference image 200 so the random errors would not accumulate while using the reference image 200.

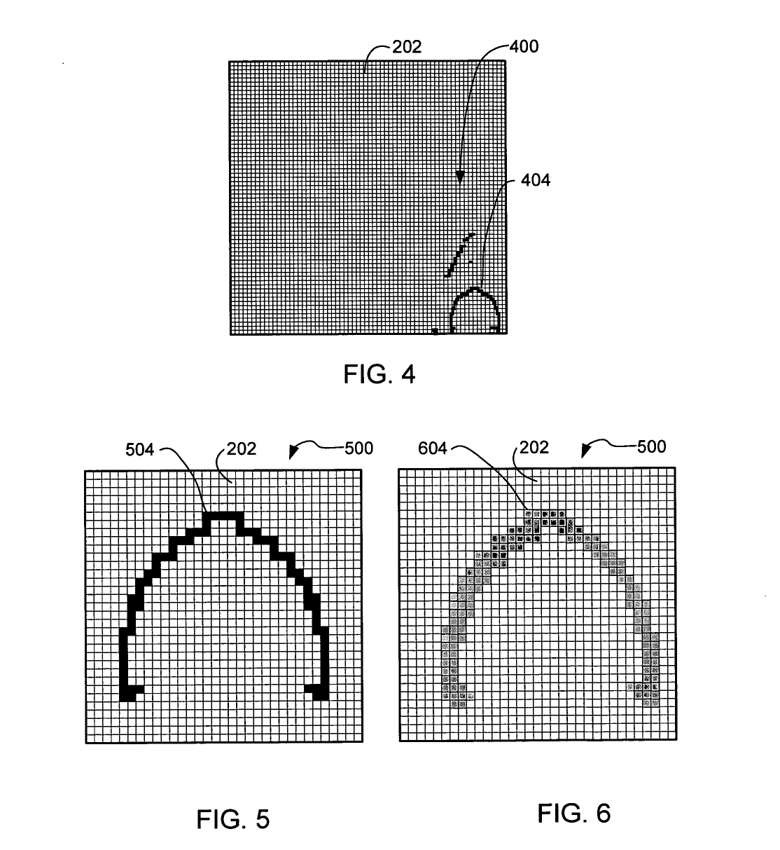

Referring now to FIG. 4, therein is shown an exemplary view of a new reference image taken by the optical mouse sensor 116 shown in FIG. 1 in accordance with an embodiment of the present invention. For example, a new reference image 400 has been taken because more than one-third of the reference image 200 of FIG. 2 is missing from the new reference image 400 of FIG. 4. The curved paper fiber 204 of FIG. 2 is now comprised of different pixels that form a curved paper fiber 404.

When the new reference image 400 is taken, the random error between the reference image 200 and the new reference image 400 will be locked into the initial location of the new reference image 400. It is this locked in random error that will be a portion of the total error when the total movement from the reference image 200 to the final image (not shown) is determined.

Referring now to FIG. 5, therein is shown a close-up example of a surface characteristic, such as a curved paper fiber 504 in an image 500. The curved paper fiber 504 is almost exactly on an integer position, which means every pixel is at maximum color intensity, such as black.

Referring now to FIG. 6, therein is shown a close-up example of the surface characteristic of FIG. 6 after approximately a half-pixel movement. The curved paper fiber 504 of FIG. 5 has landed between integer pixel locations and appears as a curved paper fiber 604, which is two pixels wide with the black color approximately half black or gray and which appears slightly blurry. Because of the blur, it is difficult to tell exactly what the exact amount of the movement is, and as a practical matter, because of the noise, there is no way of determining exactly what fraction of a pixel movement has occurred.

It will be understood that even where the same reference image is measured with no motion, there will be some error due to the noise inherent in all optical mouse sensors. Essentially, the value of every pixel will fluctuate so as to give the appearance of a change even where it does not exist and also can give the appearance of a slightly different movement different from the actual movement.

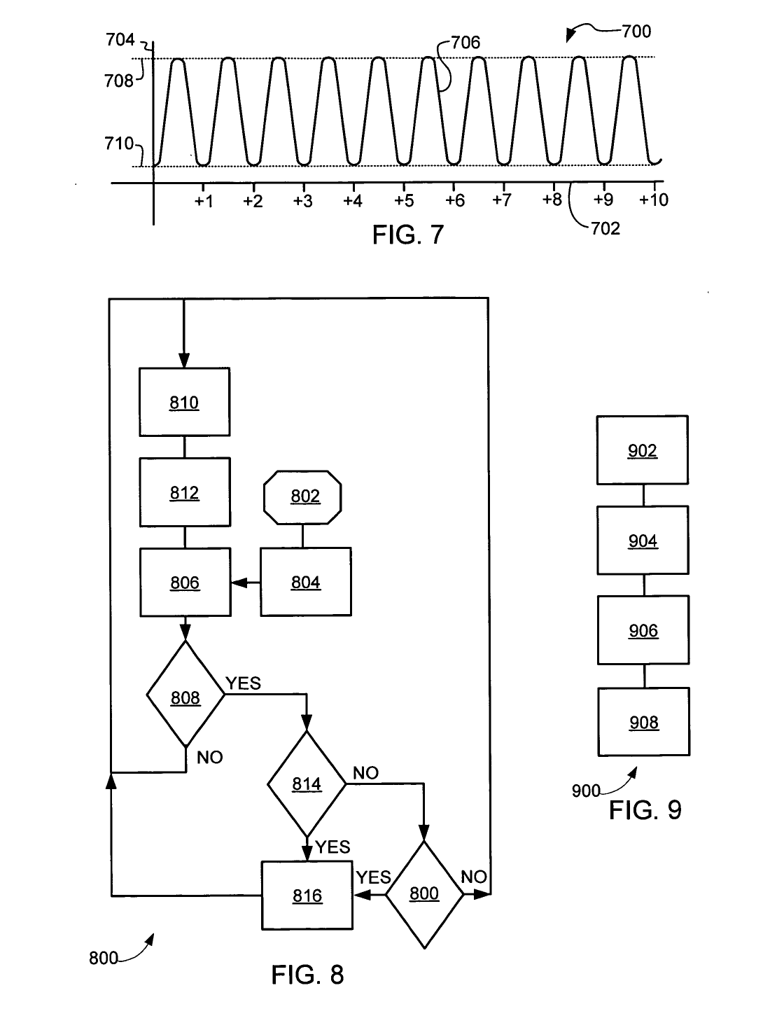

Referring now to FIG. 7, therein is shown a graph 700 of probable error versus pixel movement of an image. The pixel movement is on a number of pixels axis 702 and the probable error in measurement is on a probable error axis 704. A probable error curve 706 depicts the variations in error with the worst case being between pixels as indicated by a dotted worst case line 708, and the best cases being at integer pixels along a dotted best case line 710. Thus, the error fluctuates, and the errors are the least when close to an integer number of pixels of movement has occurred and the worst case is between pixels.

Therefore, it has been discovered that it is advantageous to delay taking reference images until the image has moved substantially to an integer number of pixels. These measurements are more accurate and more trust worthy because a smaller error will be locked in for the next subsequent measurement. This has been found to be much more accurate than just taking a new reference image after a certain amount of movement regardless of the amount of pixel movement.

It has also been discovered that it is advantageous to take new reference images at integer numbers of pixels movement both in the X and Y directions to reduce the errors that occur on re-referencing the boundaries overall.

As a result, the random errors that are locked in are primarily small random errors rather than large random errors. The errors have been found to be well under one percent after one hundred re-references.

Referring now to FIG. 8, therein is shown a flow chart of an optical navigation sensor system 800 in accordance with another embodiment of the present invention. The system 800 starts with a start command from a control in a block 802; any existing X-Y pixel measurements are cleared in a block 804; any change in the X-Y coordinates is determined compared to the reference image in a block 806; a decision is made as to whether or not a sufficient movement has been moved to take a new reference image in a block 808; if there has been insufficient movement a later image is taken in a block 810; the amount of movement between the reference image and the later image is determined in a block 812; the amount of movement is determined again in the block 806; a decision is made as to whether or not a sufficient movement has been moved to take a new reference image in the block 808; if there has been sufficient movement to take a new reference image, it is determined if the movement is close to an integer pixel movement in a block 814; if the movement is substantially an integer value, then a re-reference occurs which means the present image is used for all future comparisons in a block 816; if the movement is not close to an integer value, a decision is made whether the image has moved by more than a maximum movement in a block 818; if the image has moved more than a maximum movement, a re-reference occurs in the block 816; if the movement has not been greater than the maximum movement, then another later image is taken in the block 810.

The term “substantially an integer” is defined as being about an integer plus or minus 0.125 pixel because precision is a function of time with more accuracy requiring more time and this tolerance being an acceptable value.

The amount of movement to be considered insufficient to re-reference and the maximum movement to re-reference may be heuristically determined for an optical location measuring system 100, but it has been discovered that an insufficient movement is when under about 30% of the size of a reference image has been changed and a maximum movement is about 60% of the size of a reference image has been changed.

There is no exit out of the program because the feedback system for controlling the motor runs continuously. For example, if there is continuous movement being measured back and forth on paper and a printer, there is no need to clear the X and Y measurements. The reason for this is that the measurement is to show where the inkjet printer is over the paper at all times so the measurements need to be continuous.

Referring now to FIG. 9, therein is shown a flow chart of an optical location measuring system 900 in accordance with an embodiment of the present invention. The system includes taking a reference image in a block 902; taking a later image in a block 904; comparing the reference image and the later image to determine the number of integer and non-integer pixels of movement in a block 906; and taking a new reference image when the number of pixels of movement is substantially an integer number of pixels in a block 908.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the spirit and scope of the included claims. All matters set forth herein or shown in the accompanying drawings are to be interpreted in an illustrative and non-limiting sense.

The invention claimed is:

1. An optical location measuring system comprising:
taking a reference image;
taking a later image;
comparing the reference image and the later image to determine a number of integer and non-integer pixels of movement; and
taking a new reference image when the number of pixels of movement is substantially an integer number of pixels.

2. The system as claimed in claim 1 further comprising determining when the movement of the later image is insufficiently moved from the reference image to not take the new reference image.

3. The system as claimed in claim 1 further comprising determining when the movement of the later image is sufficiently moved from the reference image to take the new reference image.

4. The system as claimed in claim 1 further comprising continuously taking reference images, taking later images, and comparing the reference images and later images.

5. The system as claimed in claim 1 further comprising measuring the movement between the reference image and the new reference image.

6. The system as claimed in claim 1 comprising:
moving an object; and
determining the amount of movement of the object.

7. The system as claimed in claim 6 further comprising determining when the movement of the later image is more than 30% of the size of the reference image to take the new reference image.

8. The system as claimed in claim 6 further comprising determining when the movement of the later image is more than 60% of the size of the reference image to take the new reference image.

9. The system as claimed in claim 6 further comprising continuously taking reference images, taking later images, comparing the reference images and later images, and taking new reference images.

10. The system as claimed in claim 6 further comprising measuring the number of pixels moved between the reference image and the new reference image.

11. An optical location measuring system comprising:
an optical sensor for taking a reference image and a later image; and
a control processor for comparing the reference image and the later image to determine a number of integer and non-integer pixels of movement and for instructing the optical sensor to take a new reference image when the number of pixels of movement is substantially an integer number of pixels.

12. The system as claimed in claim 11 wherein the control processor is for determining when the movement of the later image is insufficiently moved from the reference image to not take the new reference image.

13. The system as claimed in claim 11 wherein the control processor is for determining when the movement of the later image is sufficiently moved from the reference image to take the new reference image.

14. The system as claimed in claim 11 wherein the control processor is for continuously causing the optical sensor to take reference images, take later images, and compare the reference images and later images.

15. The system as claimed in claim 11 wherein the control processor is for measuring the movement between the reference image and the new reference image.

16. An optical location measuring system comprising:
a motor for moving an object;
a computer for controlling the motor;
an optical sensor for taking a reference image and a later image of the object; and
a control processor for comparing the reference image and the later image to determine a number of integer and non-integer pixels of movement and for instructing the optical sensor to take a new reference image when the number of pixels of movement is substantially an integer number of pixels, the control processor for determining the amount of movement of the object and providing the amount of movement to the computer.

17. The system as claimed in claim 16 wherein the control processor is for determining when the movement of the later image is more than 30% of the size of the reference image to take the new reference image.

18. The system as claimed in claim 16 wherein the control processor is for determining when the movement of the later image is more than 60% of the size of the reference image to take the new reference image.

19. The system as claimed in claim 16 wherein the control processor is for continuously taking reference images, taking later images, comparing the reference images and later images, and taking new reference images.

20. The system as claimed in claim 16 wherein the control processor is for measuring the number of pixels moved between the reference image and the new reference image.
